(19) United States
(12) Patent Application Publication
(10) Pub. No.: US 2023/0072335 A1
(43) Pub. Date: Mar. 9, 2023

(54) OPTICAL ASSEMBLIES HAVING LASER BONDED OPTICAL FIBERS

(71) Applicant: CORNING RESEARCH & DEVELOPMENT CORPORATION, Corning, NY (US)

(72) Inventors: Leonard Charles Dabich, II, Painted Post, NY (US); Stephan Lvovich Logunov, Corning, NY (US); Mark Alejandro Quesada, Horseheads, NY (US)

(21) Appl. No.: 17/896,989

(22) Filed: Aug. 26, 2022

Related U.S. Application Data
(60) Provisional application No. 63/237,548, filed on Aug. 27, 2021.

(51) Int. Cl. G02B 6/36

(52) U.S. Cl. CPC G02B 6/3688; G02B 6/3636

(57) ABSTRACT

Assemblies having one or more optical fibers laser bonded to a substrate are disclosed. In one embodiment, an assembly includes a substrate having a surface, an array of optical elements bonded to the surface of the substrate, an epoxy disposed between individual optical elements of the array of optical elements, and a plurality of spacer elements disposed within the epoxy, wherein at least one spacer element of the plurality of spacer elements is positioned between adjacent optical elements of the array of optical elements, and the plurality of spacer elements has a coefficient of thermal expansion that is less than a coefficient of thermal expansion of the epoxy. The assembly includes a bond area between each optical element of the array of optical elements and the surface of the substrate, wherein the bond area includes laser-melted material of the substrate that bonds the optical element to the substrate.

### PRIORITY APPLICATION

This application claims the benefit of priority under 35 U.S.C. § 119 of U.S. Provisional Application No. 63/237,548, filed Aug. 27, 2021, the content of which is relied upon and incorporated herein by reference in its entirety.

### BACKGROUND

The present disclosure generally relates to methods for securing optical fibers to substrates and, more particularly methods for bonding optical fibers to substrates using a laser beam, and optical connectors and assemblies comprising optical fibers bonded to substrates using a laser beam.

Benefits of optical fiber include extremely wide bandwidth and low noise operation. Because of these advantages, optical fiber is increasingly being used for a variety of applications, including, but not limited to, broadband voice, video, and data transmission. Connectors are often used in data center and telecommunication systems to provide service connections to rack-mounted equipment and to provide inter-rack connections. Accordingly, optical connectors are employed in both optical cable assemblies and electronic devices to provide an optical-to-optical connection wherein optical signals are passed between an optical cable assembly and an electronic device.

Optical connectors may include optical fibers secured to a substrate. Typically, the optical fibers are secured to the substrate using an adhesive, which have a high coefficient of thermal expansion (CTE). The optical connectors may then be connected to another optical device to provide optical communication between optical devices. In one example, the optical connector is connected to an edge of a waveguide substrate having waveguides providing optical channels. The waveguide substrate may be a component of a photonic integrated circuit assembly, for example. In some cases, the connected optical connector and the optical device may be subjected to elevated temperatures, such as during a solder reflow process. The high CTE adhesive may cause the position of the optical fibers to shift due to the elevated temperatures and become misaligned with the optical channels of the optical device. The shifting of the optical fibers may prevent optical signals from passing between the optical connector and the optical device.

An additional source of thermal stress may be environmental testing, such as thermal shock tests. In a thermal shock test (e.g., a Telecordia thermal shock test), the device under evaluation is thermally cycled between a low temperature (e.g., −40° C.) to a high temperature (e.g., 85° C.) and back to the low temperature over a period of time (e.g., 30 seconds) for a number of cycles (e.g., 500 cycles). It has been observed that fiber optic connectors having optical fibers laser-welded to a substrate and further secured by an epoxy can fail thermal shock tests due to a cracking of optical fibers.

Accordingly, alternative methods, optical assemblies, and fiber optic connectors that employ laser-welded optical fibers and can withstand thermal shock tests may be desired.

### SUMMARY

Embodiments of the present disclosure are directed to methods for bonding one or more optical fibers (or other optical elements) to a substrate using a laser beam, as well as optical connectors and/or optical assemblies resulting from said methods. Particularly, the optical fiber acts as a cylindrical lens to focus the laser beam into the substrate, or into a thin interfacial coating on the substrate that absorbs at least 20% incident laser energy. The focused laser beam melts the substrate material, which also causes the melted substrate material to migrate into the material of the optical fiber, and bonding. The focused laser beam energy can also be absorbed by a thin absorbing film deposited on the glass substrate, melting the film, melting the substrate material, which also causes the melted substrate material to migrate into the material of the optical fiber, and bonding. Thus, the optical fiber is bonded to the substrate using a laser welding process. The cylindrical lens provided by the optical fiber may eliminate the need to have a complicated optical delivery system to locally focus the laser beam into the substrate material.

Embodiments of the present disclosure further employ features to improve ruggedness of the laser-bonded optical fibers such that the optical assemblies and fiber optic connectors satisfy environmental testing without the cracking of optical fibers. Generally, embodiments employ one or more of low coefficient of thermal expansion (CTE) epoxy, epoxy with low- or negative-CTE filler particles, and spacer elements within the epoxy having a CTE that substantially matches the CTE of the optical fibers. These features aid in reducing the thermally induced stress on the optical fibers caused by the CTE of the epoxy during solder reflow and/or environmental testing.

In this regard, in one embodiment, an assembly includes a substrate having a surface, an array of optical elements bonded to the surface of the substrate, an epoxy disposed between individual optical elements of the array of optical elements, and a plurality of spacer elements disposed within the epoxy, wherein at least one spacer element of the plurality of spacer elements is positioned between adjacent optical elements of the array of optical elements, and the plurality of spacer elements has a coefficient of thermal expansion that is less than a coefficient of thermal expansion of the epoxy. The assembly further includes a bond area between each optical element of the array of optical elements and the surface of the substrate, wherein the bond area includes laser-melted material of the substrate that bonds the optical element to the substrate.

In another embodiment, an assembly includes a substrate having a surface, an array of optical elements bonded to the surface of the substrate, and an epoxy layer disposed between individual optical elements of the array of optical elements. The epoxy layer includes an epoxy material, and a filler material comprising a plurality of particles having a coefficient of thermal expansion of less than 20 ppm/° C. The assembly further includes a bond area between each optical element of the array of optical elements and the surface of the substrate, wherein the bond area includes laser-melted material of the substrate that bonds the optical element to the substrate.

In yet another embodiment, an assembly includes a substrate having a plasma-cleaned surface, an array of optical elements bonded to the plasma-cleaned surface of the substrate, an epoxy disposed between individual optical elements of the array of optical elements, and a bond area between each optical element of the array of optical elements and the plasma-cleaned surface of the substrate, wherein the bond area includes laser-melted material of the substrate that bonds the optical element to the substrate, and the bond area has an area that is greater than or equal to 0.0075 mm².

In yet another embodiment, an assembly includes a substrate having a surface, an array of optical elements bonded to the surface of the substrate, and an epoxy disposed between individual optical elements of the array of optical elements. The epoxy has one or more of the following: a coefficient of thermal expansion of less than or equal to 30 ppm/° C., and a coefficient of thermal expansion and a Young's modulus such that a product between the coefficient of thermal expansion and the Young's modulus is less than or equal to 70,000 ppm*MPa/° C. The assembly further includes a bond area between each optical element of the array of optical elements and the surface of the substrate, wherein the bond area includes laser-melted material of the substrate that bonds the optical element to the substrate.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts a perspective view of an assembly comprising a plurality of optical fibers bonded to a substrate by a laser welding process according to one or more embodiments described and illustrated herein;

FIG. 2 schematically depicts an end view of an optical fiber positioned on a film layer disposed on a surface of a substrate according to one or more embodiments described and illustrated herein;

FIG. 3 schematically depicts ray tracing of light of a laser beam focused by the optical fiber depicted by FIG. 2 according to one or more embodiments described and illustrated herein;

FIG. 4 schematically depicts the optical fiber bonded to the substrate depicted by FIG. 2 using a laser beam according to one or more embodiments described and illustrated herein;

FIG. 5 schematically depicts a top down view of a plurality of optical fibers being bonded to a substrate by a plurality of passes of a laser beam according to one or more embodiments described and illustrated herein;

FIG. 6 is a microscope image of a plurality of optical fibers bonded to a substrate by multiple passes of a laser beam according to one or more embodiments described and illustrated herein;

FIG. 7 is a microscope image of a bond area of an optical fiber bonded to a substrate according to one or more embodiments described and illustrated herein;

FIG. 8 is a microscope image of broken optical fibers bonded to a substrate by a laser beam illustrating a strength of bond areas that bond the optical fibers to the substrate according to one or more embodiments described and illustrated herein;

FIG. 9 schematically depicts an end view of a fixture securing a plurality of optical fibers to a substrate prior to bonding the plurality of optical fibers to the substrate by a laser beam according to one or more embodiments described and illustrated herein;

FIG. 10 schematically depicts a top down view of the fixture, optical fibers and substrate depicted in FIG. 9 according to one or more embodiments described and illustrated herein;

FIG. 11 schematically depicts an example optical connector that includes optical fibers that are laser-bonded to a substrate according to one or more embodiments described and illustrated herein;

FIG. 12 is a graph illustrating thermal shock testing of a plurality of optical assemblies for comparison according to one or more embodiments described and illustrated herein;

FIG. 13 is a partial, front face view of an example optical assembly illustrating thermally induced forces acting on optical fibers;

FIG. 14 is a plot illustrating a data summary of the failure rate and properties for the epoxies provided in FIG. 12, according to one or more embodiments described and illustrated herein;

FIG. 15 is a partial, front face view of an example optical assembly having filler particles within epoxy according to one or more embodiments described and illustrated herein;

FIG. 16 is a partial, front face view of an example optical assembly having spacer elements between adjacent optical fibers according to one or more embodiments described and illustrated herein; and

FIG. 17 is a partial, front face view of an example optical assembly having a cover with positive features between adjacent optical fibers according to one or more embodiments described and illustrated herein.

### DETAILED DESCRIPTION

Embodiments described herein are directed to methods for bonding optical fibers and/or other optical elements to substrates using a laser beam as well as optical connectors and assemblies including optical fibers and/or other optical elements bonded to substrates using a laser beam. Embodiments of the present disclosure enable optical elements that have a curved shape (e.g., optical fibers) to be bonded to a flat substrate without the use of adhesives. Generally, adhesives have a high coefficient of thermal expansion (CTE). It may be desirable to subject an optical connector incorporating optical fibers secured to a substrate to a high temperature process, such as a solder reflow process. As an example and not a limitation, a connector may be attached to an optical assembly, such as an edge of a waveguide substrate of a photonic integrated circuit assembly. The photonic integrated circuit assembly and a main circuit board may be subjected to a solder reflow process after the connector is attached to a waveguide substrate of the photonic integrated circuit assembly. For effective optical communication between the optical connector and the optical channels of the photonic integrated circuit assembly (or other optical assembly), the optical fibers should be aligned to the optical channel of the photonic integrated circuit assembly with sub-micron accuracy. If adhesive is used to secure the optical fibers to the substrate of the optical connector, the elevated temperatures of the solder reflow process may cause expansion of the high-CTE adhesive. This may then cause the optical fibers to move, which can then cause the optical fibers to become misaligned with respect to the optical channels of the photonic integrated circuit assembly (or other optical assembly).

Embodiments of the present disclosure provide for a fixed pre-attachment procedure that enables the optical fibers and substrate to be subjected to elevated temperatures, such as a solder reflow process. In embodiments, a laser beam is focused by the curved surface of the optical fiber such that a diameter of the laser beam is reduced at a contact area between the optical fiber and the substrate. A film layer may be provided on a surface of the substrate that absorbs the laser beam, causing the surface of the substrate to melt. The film layer may also be configured as or into a thin interfacial coating on the substrate that absorbs at least 20% incident laser energy. The material of the substrate diffuses into the material of the optical fiber, thereby causing the optical fiber to be bonded to the substrate. Thus, the embodiments described herein enable the bonding of geometrically different components (i.e., curved optical fibers to a flat substrate) using dissimilar materials (e.g., fused silica optical fibers and a glass substrates). As used herein, the term “melt” means that the material is modified by heating in any manner that bonds the optical fiber to the substrate, and includes, but is not limiting to, actual melting of the material as well as visco-elastic swelling of the material. Also, as used herein, the terms “radius” and “diameter” in connection with an optical fiber refer to dimensional characteristics from a geometric center of the optical fiber to an outer surface of the optical fiber.

Following the pre-attachment laser-bonding procedure, the optical fiber(s) is ruggedly bonded to the substrate by application of an epoxy. As stated above, the optical assembly including the substrate, the optical fiber(s) and the epoxy may be subjected to a solder reflow process that is further downstream in the fabrication of the optical assembly. Further, optical assemblies, such as optical connectors, may be required to pass environmental testing, such as a thermal shock test. In a thermal shock test, the device under evaluation is thermally cycled between a low temperature (e.g., −40° C.) and a high temperature (e.g., 85° C.) and back to the low temperature over a period of time (e.g., 30 seconds) for a number of cycles (e.g., 500 cycles). However, it has been observed that optical assemblies including one or more optical fibers laser-bonded to a substrate that are backfilled with epoxy can fail the thermal shock test, likely because of the high coefficient of thermal expansion (CTE) of the epoxy.

Embodiments of the present disclosure address the thermally induced stress of environmental testing to provide a rugged optical assembly. Particularly, embodiments provide for techniques to minimize the impact of thermally induced stress caused by the CTE of the epoxy. As described in more detail below, embodiments employ one or more of low coefficient of thermal expansion (CTE) epoxy, epoxy with low- or negative-CTE filler particles, and spacer elements within the epoxy having a CTE that substantially matches the CTE of the optical fibers. Having a CTE that “substantially matches the CTE of the optical fibers” means that the difference between the CTE of the epoxy and the CTE of the optical fibers is less than or equal to 20 ppm/° C. These features aid in reducing the thermally induced stress on the optical fibers caused by the CTE of the epoxy during solder reflow and/or environmental testing.

Although embodiments describe the bonding of optical fibers to a substrate, embodiments are not limited thereto. Other optical elements may be bonded to a substrate such as, without limitation, lenses.

Various embodiments of methods for bonding optical fibers to substrates using a laser, and assemblies comprising a plurality of optical fibers bonded to a substrate are described in detail herein.

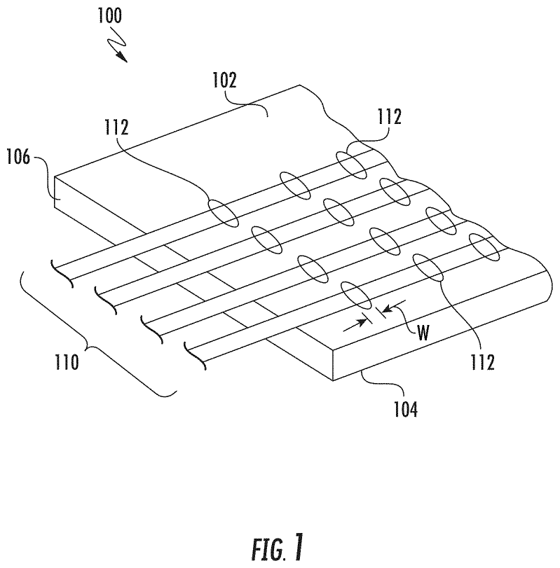

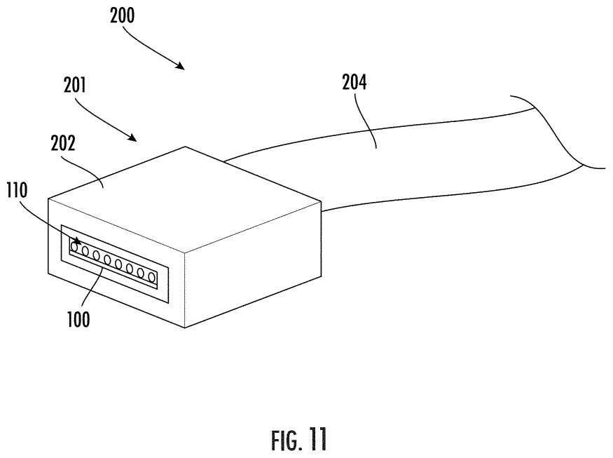

Referring now to FIG. 1, a partial perspective view of a substrate 100 with a plurality of optical fibers 110 bonded thereto is schematically depicted. As an example and not a limitation, the substrate 100 and the plurality of optical fibers 110 may be incorporated into a fiber optic connector. As an example and not a limitation, the substrate 100 and the plurality of optical fibers 110 may be incorporated into a fiber optic cable assembly 200, as illustrated schematically in FIG. 11. For example, the fiber optic cable assembly 200 may include a fiber optic connector 201 coupled to a fiber optic cable 204. The fiber optic connector 201 may include a housing 202. The substrate 100 (not shown in FIG. 11) and at least a portion of the optical fibers 110 may be located in the housing 202. It should be understood that embodiments described herein are not limited to fiber optic connectors, or fiber optic connectors of a particular type. The optical fiber and substrate assemblies may be incorporated into other optical devices.

The example substrate 100 depicted in FIG. 1 comprises a first surface 102, a second surface 104 opposite the first surface 102 and at least one edge 106 extending between the first surface 102 and the second surface 104. The substrate may be made of any low melting temperature material capable of diffusing into the material of the optical fiber 110. Generally, the melting temperature of the substrate 100 should be lower than the melting temperature of the optical fiber. An example non-limiting material for the optical fiber 110 is fused silica. Example materials for the substrate include, but are not limited to, glass, fused silica, and silicon. Non-limiting glass materials include alkaline earth boro-aluminosilicate glass (e.g., as manufactured and sold under the trade name Eagle XG® by Corning Incorporated of Corning, N.Y.) and alkali-aluminosilicate glass (e.g., as manufactured and sold under the trade name Gorilla® Glass). As non-limiting examples, the softening point for Eagle XG® is about 970° C. Other non-limiting examples of glass include BK7 glass, soda lime and other glasses with flat or polished surfaces. For such glasses, the softening point may be within a range of about 650° C. to about 800° C., including endpoints. The softening point for fused silica is about 1715° C., so any glass with softening point less than 1500-1600° C. may be acceptable. It should be understood that the substrate 100 may be made of other low-melting temperature materials.

The thickness of the substrate 100 is not limited by this disclosure. The thickness of the substrate 100 may be any thickness as desired for the end-application of the optical fiber 110 and substrate 100 assembly.

The plurality of optical fibers 110 are bonded to the first surface 102 of the substrate 100 by one or more laser bonding processes as described in detail below. The optical fibers 110 are stripped of any jacket or outer layers to remove high CTE material. Although FIG. 1 depicts four optical fibers 110, it should be understood that any number of optical fibers 110 may be bonded to a surface of the substrate 100 (i.e., one or more optical fibers 110). It should also be understood that the optical fibers 110 may be bonded to the second surface 104, or both the first surface 102 and the second surface 104.

The optical fibers 110 may be fabricated from any material having a higher melting temperature than that of the substrate 100. As noted above, the optical fibers 110 may be fabricated from fused silica. The optical fibers 110 have a round shape in cross section. However, the optical fibers 110 may be elliptical in shape. As described in more detail below, the optical fibers 110 should have curved surfaces that focus a laser beam such that a size (e.g., a diameter) of the laser beam at the contact area between the optical fiber 110 and the first surface 102 of the substrate 100 is smaller than a size of the laser beam as it enters the optical fiber 110.

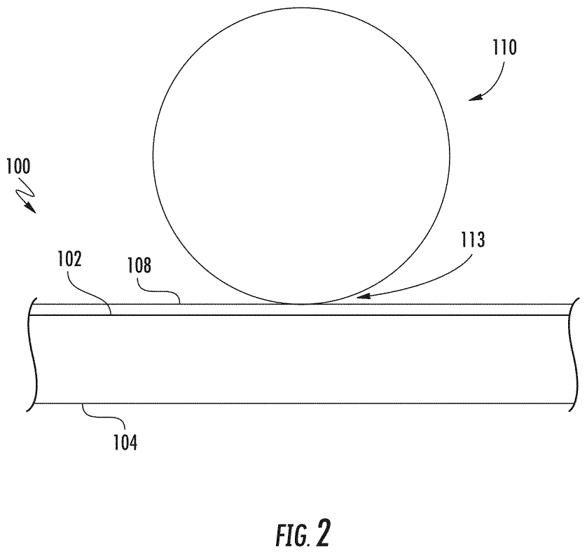

Each optical fiber 110 is bonded to the first surface 102 of the substrate 100 at one or more bond areas 112 along the length of the optical fiber 110. It is noted that the bond areas 112 are denoted by ellipses in FIG. 1. As described in detail below, the bond areas 112 are regions of the first surface 102 of the substrate 100 where the optical fiber 110 contacts the first surface 102 of the substrate 100 and the material of the substrate 100 is melted and diffused into the material of the optical fiber 110. The bond areas 112, which are formed by the application of a laser beam, weld the optical fiber 110 to the first surface 102. It is noted that, in some embodiments, heating of a contact area 113 (FIG. 2) between optical fiber 110 and the first surface 102 of the substrate 100 may be provided by application of electromagnetic energy (e.g., microwaves) rather than a laser beam.

Any number of bond areas 112 may be provided along the length of the optical fiber 110. Bonding the optical fibers 110 to the surface of the substrate 100 may eliminate the need for organic materials, such as epoxy, to secure the optical fibers 110 to the substrate 100. Therefore, the assembly of the substrate 100 and the optical fibers 110 may be subjected to elevated temperatures of a solder reflow process without movement of the optical fibers 110 due to the presence of high CTE epoxy or other high CTE material.

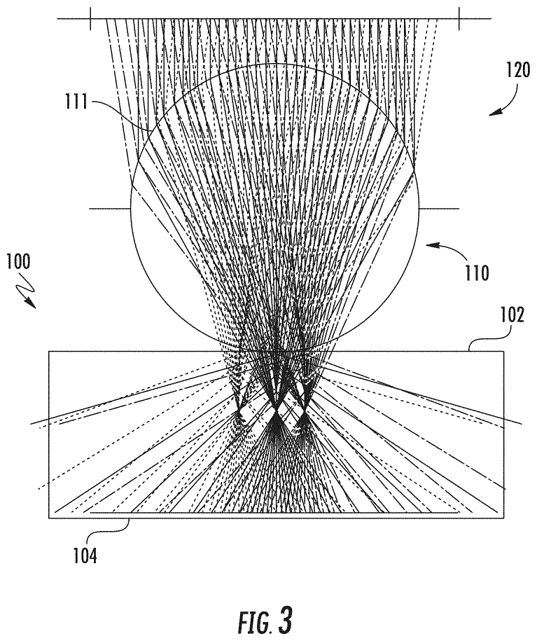

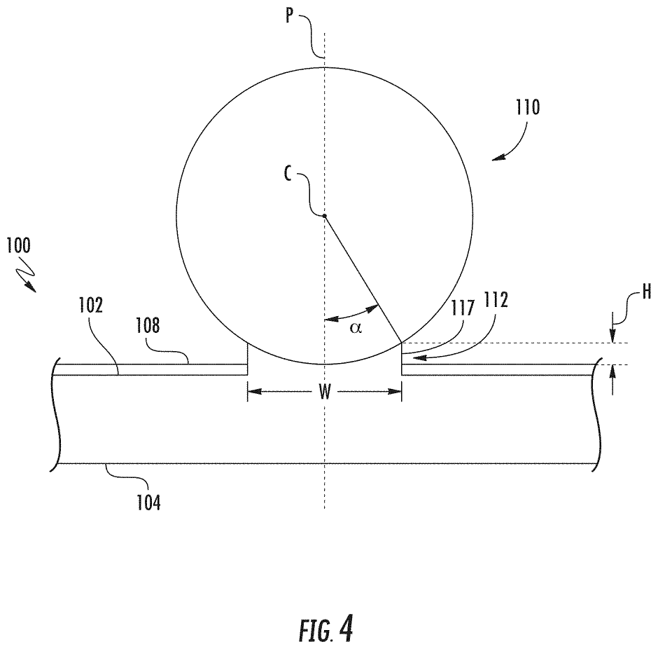

Referring now to FIGS. 2-5, an example process for laser welding optical fibers 110 to a substrate 100 is schematically illustrated. Referring first to FIG. 2, an end view of an optical fiber 110 disposed on a substrate 100 is schematically depicted. A film layer 108 is deposited on the first surface 102 (or the second surface 104). The film layer 108 is configured to absorb the laser beam, and raise the temperature of the first surface 102 to locally heat and melt the substrate 100, as described in more detail below and illustrated in FIGS. 3 and 4. The material of the film layer 108 should be chosen such that it is absorptive to the wavelength of the laser beam. As a non-limiting example, the film layer 108 should have an absorbance of greater than or equal to 20% as measured by reflectance and transmission of the sample. The absorbance is calculated as 100% minus the transmission value minus the reflectance value.

The thickness of the film layer 108 is not limited by this disclosure. It is noted that the thickness of the film layer 108 is exaggerated in FIGS. 2 and 4 for illustrative purposes. As a non-limiting example, the thickness of the film layer 108 is less than or equal to 1 μm. Non-limiting materials for the film layer 108 include metals (e.g., stainless steel), glasses (e.g., low melting glass (LMG)), ZnO, TiO2, Nb2O5, an electromagnetic-absorbing oxide material, and an electromagnetic-absorbing nitride material among others. The material and thickness of the film layer 108 should be such that the material of the substrate 100 at the first surface 102 melts due to the absorption of the laser beam by the film layer 108.

Still referring to FIG. 2, an optical fiber 110 is disposed on the film layer 108 such that a contact area 113 is defined by contact between the optical fiber 110 and the film layer 108. The contact area 113 generally extends along the length of the optical fiber 110 that it is in contact with the film layer 108. It is noted that, in some embodiments, no film layer 108 is provided and the optical fiber(s) 110 is disposed directly on the first surface 102 (and/or second surface 104) of the substrate 100.

The optical fiber 110 has a curved surface, and has a generally circular shape. The shape of the optical fiber 110 enables the optical fiber 110 to act as a cylindrical lens that focuses an incident laser beam 120 at the contact area 113 without a complicated optical delivery system. Referring now to FIG. 3, the example optical fiber 110 of FIG. 2 is shown having a laser beam 120 passing therethrough. The incident laser beam 120 is weakly focused as it enters the optical fiber 110. The curved upper surface 111 of the optical fiber 110 that receives the laser beam 120 focuses the laser beam 120 such that a size (e.g., diameter) of the laser beam 120 at the contact area 113 is smaller than a size of the laser beam 120 as the laser beam 120 enters the optical fiber 110 (i.e., at the upper surface 111 of the optical fiber 110). It is noted that the different line types depicting the ray-tracing of the laser beam 120 correspond to different input angles of the coherent laser beam due to the numerical aperture of the focusing lens (not shown). Thus, FIG. 3 schematically depicts how the optical fiber 110 acts as a cylindrical lens that focuses the laser beam, thereby reducing the size of the laser beam at the contact area 113 without the need for complicated optics. The reduction in size of the laser beam causes the film layer 108 to be heated quickly and provide the formation of a bond area proximate the contact area 113.

The properties of the laser beam 120 should be such that the laser beam melts the material of the substrate 100 at the contact area 113, thereby causing diffusion between the material of the optical fiber 110 and the material of the substrate 100. The laser beam may be a continuous wave (CW) or quasi CW laser beam (i.e., a pulsed laser beam having a high repetition rate). The wavelength of the laser beam 120 should be such that the laser beam 120 is absorbed by the film layer 108 to melt the material of the substrate 100. For example, the wavelength of the laser beam 120 may be in the visible, ultraviolet or near infrared spectral bands. As a non-limiting example, the wavelength of the laser beam 120 may be within a range of 0.3 to 1.7 μm, including endpoints.

As a non-limiting example, the power of the laser beam 120 may be in a range of 0.5 W to 10 W including endpoints, and be single mode for focusing by the optical fiber 110. The diameter of the laser beam 120 at the upper surface 111 of the optical fiber 110 should be equal to or less than the diameter of the optical fiber 110, such as, without limitation between 80 μm and 400 μm, including endpoints. The duration of time that the laser beam 120 is focused by the optical fiber 110 should be long enough to melt the material of the substrate 100 and to form a bond between the optical fiber 110 and the substrate 100.

As noted above, in some embodiments, no film layer is utilized to absorb the laser beam. In such embodiments, a high-power sub-picosecond pulsed laser is used without an absorbing film layer. The high-energy pulses melt the material of the substrate 100 without a need for the absorbing film layer. Due to the material non-linearity and multiphoton absorption process, absorption occurs without an absorbing film. Non-limiting example power values of a sub-picosecond pulsed laser include a power density more than 0.5 GW/cm² with an average power of greater than 200 mW.

FIG. 4 schematically depicts the optical fiber 110 after it is laser welded to the first surface 102 of the substrate 100 by the laser beam 120. Particularly, FIG. 4 depicts the topography of a bond area 112 that bonds the optical fiber 110 to the substrate 100. The film layer 108 absorbs the laser beam 120, which creates heat that causes the material of the substrate 100 to melt at the contact area 113. The melted material of the substrate 100 diffuses into the optical fiber 110, and also flows up toward the optical fiber 110, thereby forming a bond area 112 having a height H as measured from the surface of the film layer 108 (or the first surface 102 of the substrate 100) to an edge 117 of the bond area 112 that contacts the optical fiber 110. The height H of the bond area 112 is not limited by this disclosure. As an example and not a limitation, the height H of the bond area 112 may be from 0.2 to 10 μm.

The width W of the bond area 112 is dependent on the diameter of the laser beam 120 after the laser beam 120 is focused by the optical fiber 110. Additionally, an angle α is defined between a plane P through a center C of the optical fiber 110 and an edge 117 of the bond area 112. The value of the angle α depends on the height H and the diameter of the optical fiber. As a non-limiting example, for a range of the height H from 0.2 μm to 10 μm and a range of optical fiber diameter from 80 μm to 400 μm, the range of a is from 2.6 degrees to 40 degrees.

As shown in FIG. 4, the bond area 112 is a region of expanded glass that creates a “V-groove” matching the shape of the optical fiber 110 and providing significant contact area with the optical fiber 110. This contact area increases the bonding strength of the optical fiber 110 to the first surface 102 of the substrate 100.

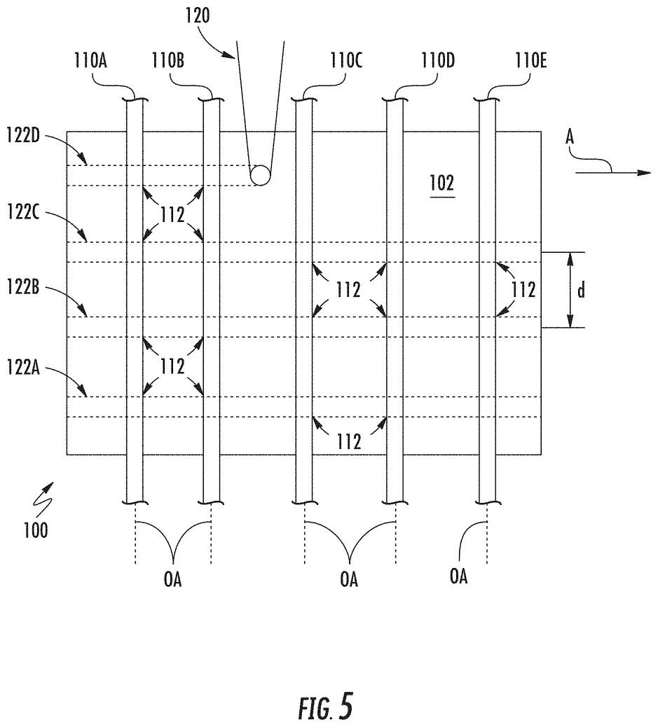

Multiple optical fibers 110 may be sequentially welded to the first surface 102 (and/or the second surface 104) of the substrate 100 to increase bonding strength. FIG. 5 schematically depicts a top-down view of optical fibers 110A-110E disposed on a first surface 102 of a substrate 100. The laser beam 120 is moved relative to the optical fiber 110A-110E in a direction A that is transverse to an optical axis OA of the optical fibers 110A-110E. In the example of FIG. 5, the direction A of the laser beam 120 is perpendicular to the optical axis OA of the optical fibers 110A-110E. However, embodiments are not limited thereto. It is noted that the laser beam 120 may be translated relative to the substrate 100, or the substrate 100 may be translated relative to the laser beam 120.

The laser beam 120 sequentially traverses and welds multiple optical fibers 110A-110E as it travels along direction A in a first pass 122A. As the laser beam 120 enters an optical fiber 110A-110E, it is focused as described above and creates a bond area 112. In some embodiments the material of the substrate 100 outside of the contact areas between the optical fibers 110A-110E and the substrate 100 is not melted by the laser beam 120. Rather, material is only melted at the contact areas (e.g., contact area 113 as shown in FIG. 2) because of the focusing effect of the optical fibers 110A-110E on the laser beam 120.

As shown in FIG. 5, multiple passes 122A-122D of the laser beam 120 may be performed to weld the optical fibers 110A-110E to the substrate 100 at multiple bond areas 112 along the length of the optical fibers 110A-110E. For example, a position of the laser beam 120 may be shifted by a distance d in a direction parallel to the optical axis OA of the optical fibers 110A-110E after completion of a pass to perform a subsequent pass. The distance d is not limited by this disclosure, and may depend on the desired number of bond areas 112 desired for each optical fiber 110A-110E. In FIG. 5, a fourth pass 122D is not yet complete as the laser beam 120 approaches a third optical fiber 110C. As a non-limiting example, the translation speed of the laser beam 120 with respect to the substrate 100 is in the range of 5 mm/s to 200 mm/s, including endpoints.

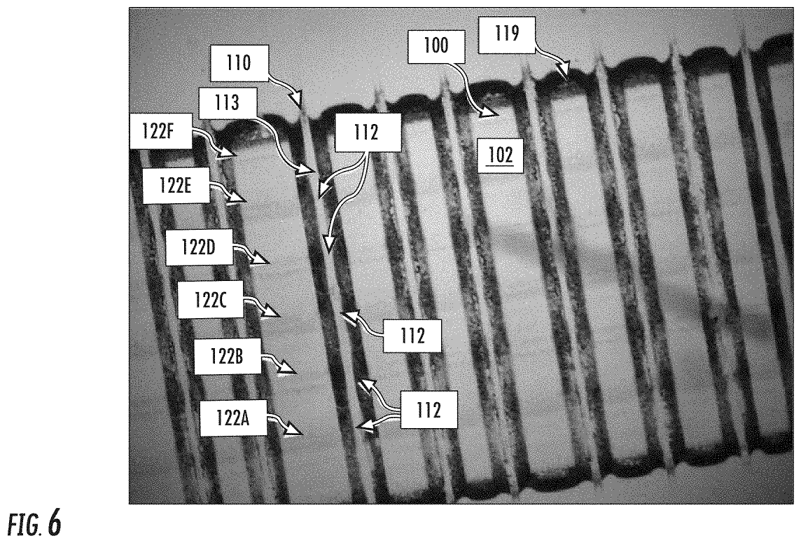

Referring now to FIG. 6, a microscope image of a plurality of optical fibers 110 bonded to a first surface 102 of a substrate 100 is provided. It is noted that the dark regions 119 of the image is index matching fluid. The microscope image of FIG. 6 was taken by disposing the index matching fluid on the first surface 102 of the substrate 100 and then placing a glass substrate on top of the optical fibers 110 such that the optical fibers 110 and the index matching fluid was disposed between the substrate 100 and the glass substrate. In this manner, the optical fibers 110 and their contact areas 113 become visible in the microscope image.

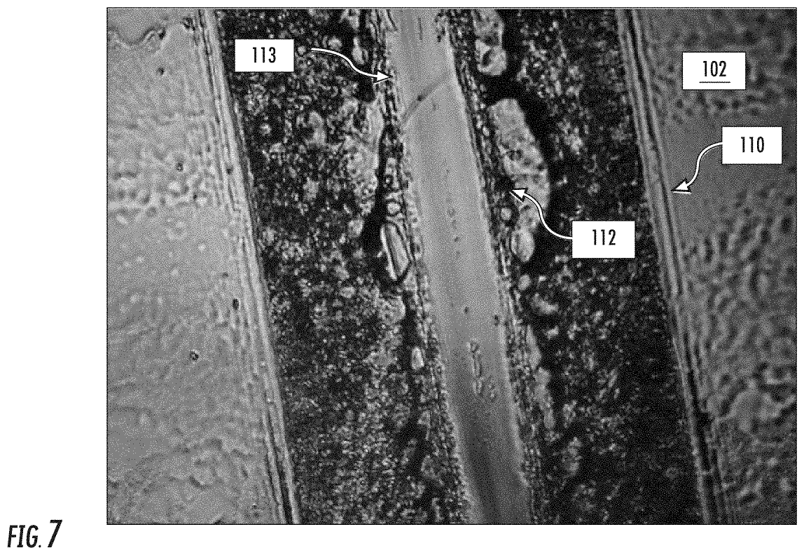

The substrate 100 shown in FIG. 6 is a 0.7 mm thick Corning® Eagle XG® glass substrate manufactured and sold by Corning Incorporated. The optical fibers 110 are Corning® SMF-28® optical fibers. A 20 nm thick stainless steel film layer is disposed on the first surface 102 of the substrate 100 to absorb the laser beam. The laser beam used to weld the optical fibers was a TEM 00 mode 355 nm wavelength laser beam having a power of 2.5 W and translated at a speed of 15 mm/s. Six passes 122A-122F of the laser beam were performed. The darker lines in the image show the path of the six passes 122A-122F. The distance between individual passes 122A-122F was about 0.2 mm. The laser beam 122 welds the optical fibers 110 to the first surface 102 at the bond areas 112. It is noted that not all of the bond areas 112 are labeled in FIG. 6 for ease of illustration. FIG. 7 depicts a close-up microscope image depicting an individual bond area 112. FIG. 7 shows that there is minimal damage to the optical fiber 110 or the substrate 100 at the bond area.

In another example, a 1550-nm single-mode CW laser was used to weld the Corning® SMF-28® optical fibers to the Eagle XG® substrate with the 6 W laser power and 120 mm/s beam scanning speed.

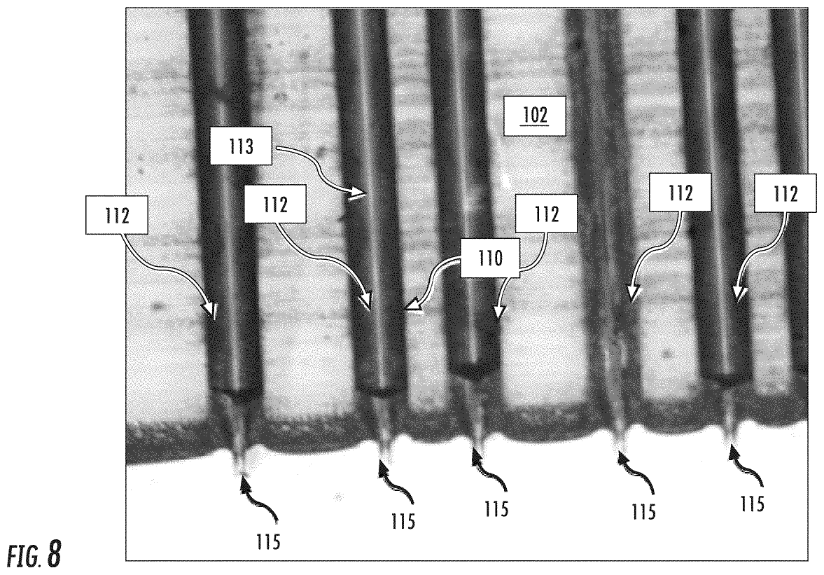

The resulting bonds of the optical fibers 110 to the substrate 100 in the example depicted in FIGS. 6 and 7 are strong. FIG. 8 is a close-up microscope image of optical fibers having broken ends 115 that were broken by lifting the optical fibers off of the substrate 100. Rather than being lifted at the bond areas 112 where the optical fibers 110 are bonded to the first surface 102 of the substrate 100, the optical fibers 110 were broken along their length, which is indicative of the bonding strength of the laser processes described herein.

Additionally, it was found that vertical displacement of the bottom of the optical fibers 110 at the bond areas was minimal. A Zygo interferometer was used to measure the surface topography of the substrate 100 under the optical fibers 110 as well as the bottoms of the optical fibers 110. Based on the analysis, the displacement of the bottoms of the optical fibers 110 is less than 0.2 μm at the bond areas. Thus, the optical fibers 110 remain in substantially the same position after laser welding as before laser welding. Accordingly, the process will lead to increased optical coupling between the optical fibers 110 of the fiber optic connector 201 (FIG. 11) and waveguides (not shown) to which the optical fibers 110 are connected because the optical fibers 110 are not vertically displaced after welding.

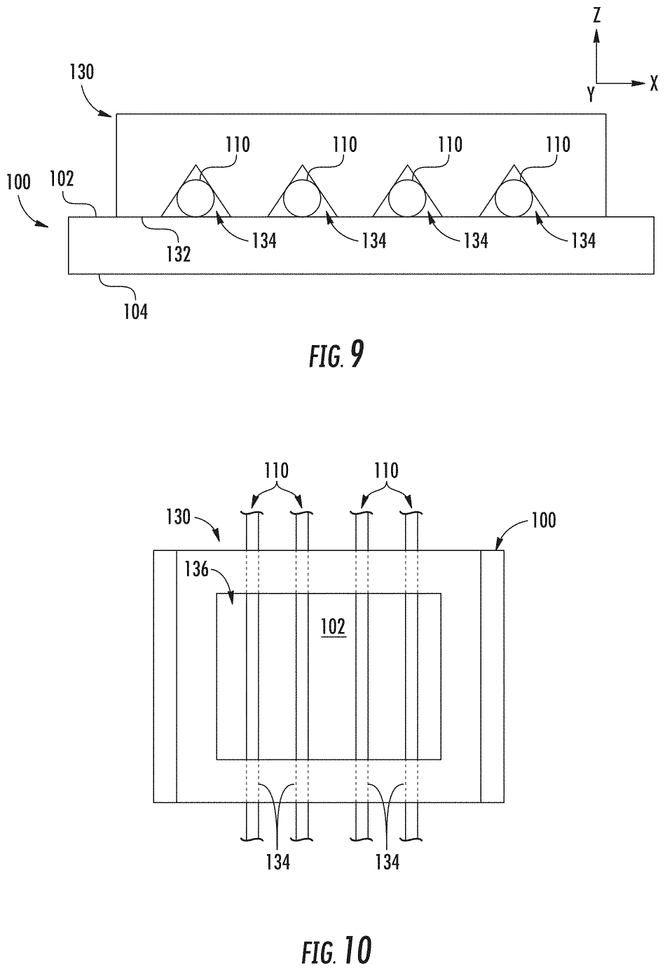

Referring now to FIGS. 9 and 10, an example, non-limiting fixture utilized to maintain the optical fibers in desired positions before the laser welding process. FIG. 9 is an end view of an assembly comprising a substrate 100, a plurality of optical fibers 110, and a fixture 130. FIG. 10 is a top-down view of the assembly depicted in FIG. 9. The fixture 130 may be fabricated from any suitable material, such as glass, metal or polymers, for example.

As shown in FIG. 9, the fixture has a bottom surface 132 having a plurality of grooves 134. The fixture 130 is disposed on the substrate 100 such that the bottom surface 132 of the fixture 130 contacts (or nearly contacts) the first surface 102 (and/or the second surface) or any film layers that are disposed on the first surface 102. The plurality of optical fibers 110 are positioned within the plurality of grooves 134. The plurality of grooves 134 of the fixture 130 position the plurality of optical fibers 110 at known locations on the x- and z-axis. As a non-limiting example, the precise placement of the fixture 130 on the substrate 100 may be performed by an active alignment process. Once in place, the fixture 130 may be mechanically clamped or otherwise secured to the substrate 100.

Referring now to FIG. 10, the fixture 130 has an open region 136 that exposes the optical fibers 110. The plurality of grooves 134 are interrupted by the open region 136. Thus, the laser beam 120 may be translated across the exposed optical fibers 110 to weld the optical fibers 110 to the substrate 100. As shown in FIG. 5, multiple passes of the laser beam 120 may be provided in the open region 136 to bond the optical fibers 110 to the substrate at multiple bond areas. After the optical fibers are bonded to the substrate 100, the fixture 130 may be removed from the substrate 100 and the assembly may be further processed.

Additional information regarding laser bonding optical elements such as optical fibers to a substrate is provided by U.S. Pat. Nos. U.S. Pat. Nos. 10,345,533, 10,422,961, 10,545,293, and 10,746,937, which are hereby incorporated by reference in their entireties.

As stated above, forces applied to the optical fibers 110 may cause the bond area 112 to fracture and fail. In cases where epoxy is used to further secure the optical fibers to the substrate or package the optical fibers and substrate into a connector housing, thermally induced stress due to the high coefficient of thermal expansion of the epoxy relative to the optical fibers 110 and the substrate 100 can apply forces to the optical fibers 110 that may lead to optical fiber breakage.

To evaluate the effect of thermally induced stress on optical assemblies, optical assemblies including eight optical fibers that were laser-bonded and epoxied to a substrate were subjected to 50 or 100 cycles of temperature change between −196° C. and 120° C. in approximately 30 seconds (per cycle). The low temperatures (−196° C./77° K) were achieved by alternately exposing the optical assemblies to liquid nitrogen (which had the low temperatures), and the high temperatures (120° C.) were achieved by exposing the optical assemblies to a hot plume from a heat gun (the plume having the 120° C.). This test shows very good correlation with regular Telecordia thermal shock test (−40° C. to 85° C.) in 500 cycles, but provides much faster results. The accelerated test enabled screening of multiple types of epoxy and laser welding conditions.

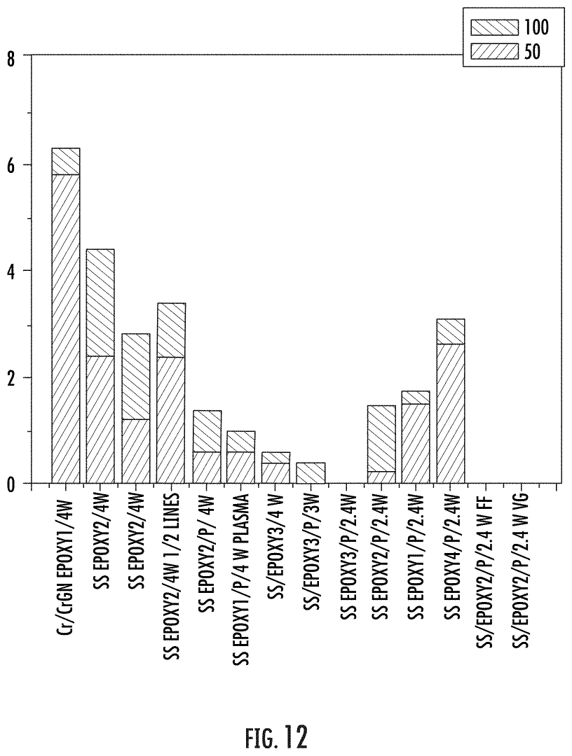

Optical assemblies fabricated using different types of epoxies and laser welding conditions were fabricated and evaluated. FIG. 12 illustrates a graph depicting the results. The Y-axis indicates the average number of failed optical fibers in the eight-fiber optical assemblies. The X-axis provides the film composition, the epoxy used, whether or not plasma cleaning was performed, and the laser power used at a scanning speed of 50 mm/s (film composition/epoxy used/plasma/laser power). In FIG. 12, “Cr/CrON” is Cr film with a CrON second layer and “SS” is stainless steel (80 nm). Plasma cleaning is indicated by the “P”. When no plasma cleaning is used there is no “P”.

Table 1 below provides detailed properties regarding the epoxies that were used. HYB-353 is fabricated by Epoxy Technology, Inc. of Billerica, Mass. A535 Å and A535 AN are fabricated by Addison Clear Wave Coatings, Inc. of St. Charles, I.L. Norland 61 is a photopolymer fabricated by Norland Products of Cranbury, N.J.

TABLE 1

| | | | Glass | | | | |
|---|---|---|---|---|---|---|---|
| | | | transition | | Young's | | Y*CTE, |
| | Viscosity, | Hardness, | point | CTE, | modulus | shrinkage, | MPa*ppm/ |
| Epoxy | cP | shore D | (Tg), ° C. | ppm/° C. | (Y), MPa | % | ° C. |
| HYB-353 | 1500 | 83 | 80 | 46 | 2500 | 1.5 | 115000 |
| (epoxy 4) | | | | | | | |
| A535A | 1200 | 90 | 136 | 42 | 1700 | <0.5 | 71400 |
| (epoxy 1) | | | | | | | |
| A535 AN | 4000 | 95 | 165 | 28 | 2300 | <1 | 64400 |
| (epoxy 3) | | | | | | | |
| Norland 61 | 300 | 85 | 10 | 200 | 930 | 1.5 | 186000 |
| (epoxy 2) | | | | | | | |

For practical purposes, the viscosity of the polymer should be lower than about 10,000 cP, and hardness D should be greater than about 80 because it is desirable to have the applied polymer wick into the fiber array interstitial regions as quickly as possible. Typically, epoxy has lower CTE below the glass transition point Tg, and higher CTE above Tg, so Tg should be ideally higher than highest specification temperature of the device.

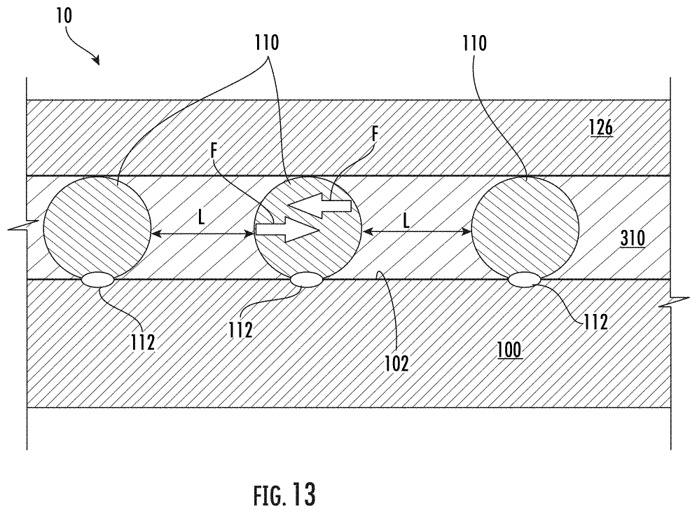

FIG. 13 is a partial close-up view of an end face of an optical assembly 10 wherein optical fibers 110 are laser-bonded to a surface 102 of a substrate 100 at bond areas 112. A cover 126 is positioned over the optical fibers 110, and an epoxy 310 is backfilled between the cover 126 and the substrate, as well as between adjacent optical fibers 110. During thermal cycling (e.g., during a thermal shock test), expansion of the epoxy 310 causes forces F to be applied to the optical fibers 110. Thermal expansion leads to elongation of the epoxy, as provided by Equation 1.

ΔL/L=CTE*ΔT (1),
where ΔT is elongation, L is distance between optical fibers, and ΔT is the change of temperature.

The resulting elongation creates a force F pushing on individual optical fibers, as provided by Equation 2:

F=Y*ΔL=Y*L*CTE*ΔT (2),
where Y is Young modulus, and polymer of the epoxy is in an elastic regime.

Therefore, the product of Young's modulus and CTE plays major role for applying force to the optical fibers due to geometry associated with laser welding, i.e., narrow necked bond area with large body and large force momentum applied to the optical fiber. The last column in Table 1 provides the product of Young modulus and CTE, which is most preferential for epoxy 3, and least for epoxy 2 and epoxy 4.

It is further noted that if the epoxy has high shrinkage, it may create voids in the epoxy between optical fibers, thereby creating more asymmetric force leading to additional misbalance of forces applied to the optical fibers.

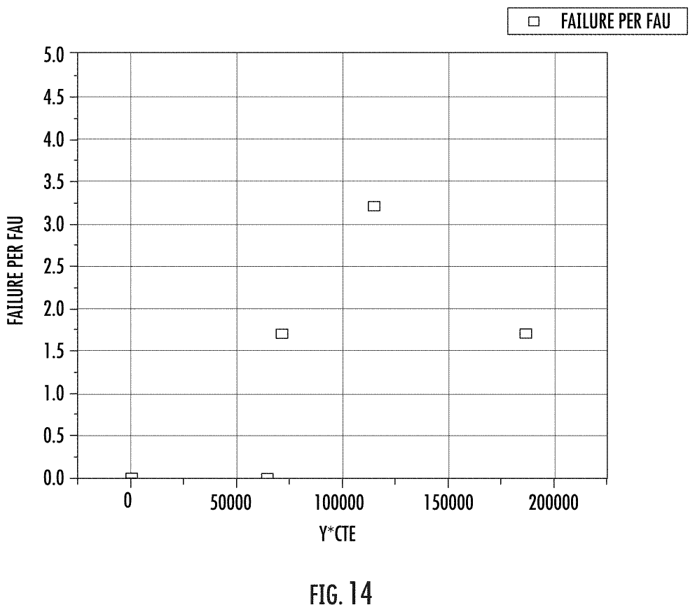

FIG. 14 is a plot showing a data summary of the failure rate and properties for the epoxies provided in Table 1 and FIG. 12, where data for the same laser weld conditions and same composition of the substrate and film are collected. FIG. 14 shows that epoxies having low CTE are desirable because low CTE lowers the product of the Young's modulus and the CTE. It is noted that the Young's modulus may be greater than about 500 MPa (as a non-limiting example, within a range of 500 MPa to 3000 MPa, including endpoints) to facilitate subsequent dicing and polishing steps of the optical assembly. As a non-limiting example, the epoxy chosen has a CTE that is less than or equal to 30 ppm/° C. As additional non-limiting examples, the epoxy chosen has a difference in CTE from the CTE of the optical fiber(s) of less than 50 ppm/° C., less than 25 ppm/° C., or less than 10 ppm/° C. As further non-limiting example, the epoxy chosen has a Young's modulus and a CTE such that the product between the Young's modulus and the CTE is less than or equal to 70,000 ppm*/MPa ° C. As shown by FIG. 14, there are no failures below 70,000 ppm*MPa/° C. Such epoxies minimize the force F on the optical fiber(s) during solder reflow and thermal shock tests. Epoxies having the qualities described above may enable the optical assembly (i.e., one or more optical fibers laser-bonded to a substrate and an epoxy surrounding the one or more optical fibers) to satisfy a thermal shock test comprising one-hundred thermal cycles between −196° C. and 120° C. in thirty seconds. An optical assembly satisfies the thermal shock test when each of the one or more optical fibers have an insertion loss of less than or equal to 0.2 dB and a return loss of less than or equal to −20 dB after the thermal shock test.

Additional features to help the optical assembly satisfy the thermal shock test are described below.

In embodiments, another approach to lower the CTE of an epoxy having an inherently high CTE (e.g., a silsesquioxane (SSQ) polymer, such as MPOSS 1173 manufactured by Sigma Adlrich of Darmstadt, Germany) is to include filler particles having a material that has low or negative CTE to provide an epoxy layer having an effective CTE that is lower than the material of the epoxy itself.

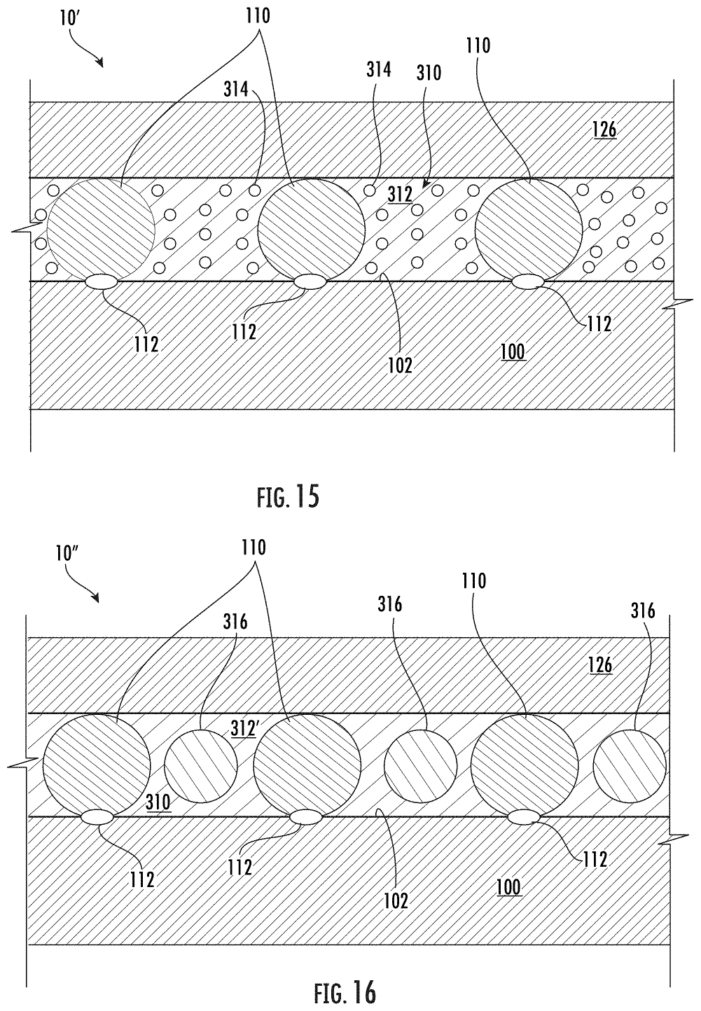

FIG. 15 illustrates an example optical assembly 10′ having an epoxy layer 312 comprising an epoxy material 310 (e.g., SSQ) and a plurality of filler particles 314 (i.e., a filler material). It should be understood that the filler particles 314 are not shown to scale for illustrative purposes. As a non-limiting example, the filler particles 314 may have a diameter that is less than or equal to 200 μm. less than or equal to 150 μm, less than or equal to 100 μm, less than or equal to 50 μm, or less than or equal to 25 μm. The type of epoxy material 310, the CTE of the filler particles 314, and the amount of the filler particles 314 included in the epoxy material 310 are chosen such that the product of the resulting Young's modulus and the resulting CTE of the epoxy layer 312 is less than or equal to 70,000 ppm*MPa/° C. A non-limiting material for the filler particles 314 includes zirconia tungstate particles, which is an inorganic material having a negative CTE. It should be understood that other materials may be used for the filler particles 314 such as, without limitation, silica particles. In some embodiments, the CTE of the filler particles 314 may be less than 20 ppm/° C.

In an experiment, two native epoxies were evaluated for their CTE: MPOSS 1173 (SSQ) and Norland 61 (N61) fabricated by Norland Products of Cranbury, N.J. The CTE of the two epoxies were evaluated over a first temperature range of −20° C. to 40° C. and a second temperature range of 70° C. to 80° C. These two epoxies were compared with a SSQ epoxy loaded with 72 μm diameter zirconia tungstate particles to a 20% weight concentration (w/w) and a N61 epoxy loaded with 72 μm diameter zirconia tungstate particles to a 30% weight concentration (w/w), respectively. Table 2 below illustrates the resulting CTE for the four epoxy samples over the temperature ranges.

TABLE 2

| | Zr-W-state | | |
|---|---|---|---|
| | loading | CTE (ppm/° C.) | CTE (ppm/° C.) |
| Sample | (w/w) % | −20° C. ↔ 40° C. | 70° C. ↔ 85° C. |
| SSQ | 0% | 102.9 ppm/° C. | 108.2 ppm/° C. |
| SSQ-loaded | 20% | 81.0 ppm/° C. | 91.0 ppm/° C. |
| N61 | 0% | 179.9 ppm/° C. | 214.6 ppm/° C. |
| N61-loaded | 30% | 90.1 ppm/° C. | 198.8 ppm/° C. |

The data in Table 2 illustrate reducing a given epoxy's CTE by the technique of blending negative CTE materials in the epoxy material, which in turn reduces the thermal expansion forces experience by individual fibers during thermal shock cycles. A 20% addition of the zirconia tungstate particles to the SSQ polymer is shown to lower its CTE about 21% over the −20° C.-40° C. range, and about 16% over the 70° C.-85° C. range. A 30% addition of the zirconia tungstate particles to the N61 polymer is shown to lower its CTE about 50% over the −20° C.-40° C. range, and about 7% over the 70° C.-85° C. range.

Accordingly, low (e.g., less than 20 ppm/° C.) or negative CTE particles may be provided in epoxy materials to lower the effective CTE of the epoxy layer 312 such that the optical assembly can satisfy the thermal shock test.

Referring now to FIG. 16, another non-limiting embodiment of an optical assembly 10″ having a modified epoxy layer 312′ is illustrated. The epoxy layer 312′ of this example, includes an epoxy material 310 and one or more spacer elements 316 disposed within the epoxy material 310 such that at least one spacer element 316 is positioned between adjacent optical fibers (or other optical elements). The spacer elements 316 are fabricated with a low CTE material that has a CTE that is less than the CTE of the epoxy. As one non-limiting example, the spacer elements 316 are made of a material having a CTE that is the average of the CTE of the optical fibers 110 and the CTE of the epoxy material 310. As another non-limiting example, the CTE of the spacer elements 316 substantially matches the CTE of the optical fibers such that the difference between the CTE of the epoxy and the CTE of the optical fibers is less than or equal to 20 ppm/° C., less than or equal to 10 ppm/° C., less than or equal to 5 ppm/° C., or less than or equal to 1 ppm/° C. For example, the spacer elements 316 may be fabricated from glass, such as, without limitation, non-functional optical fibers. The non-functional optical fibers may be made of the same material as the optical fibers 110. However, it should be understood that the spacer elements are not limited to optical fibers. Generally, the CTE of the spacer elements 316 should be such that it minimizes the thermally induced cantilevering forces between the epoxy material pushing up against the optical fibers that occur during thermal cycling events.

As shown in FIG. 16, the spacer elements 316 take up volume between adjacent optical fibers 110, which minimizes the amount of epoxy material 310 located between adjacent optical fibers 110 and therefore minimizes the amount of thermally induced force on the optical fibers 110. The spacer elements 316 allow for the use of higher CTE epoxy materials (e.g., SSQ, N61), which may be less expensive than lower CTE epoxy materials, and may enable the optical assembly 10″ to satisfy the thermal shock test.

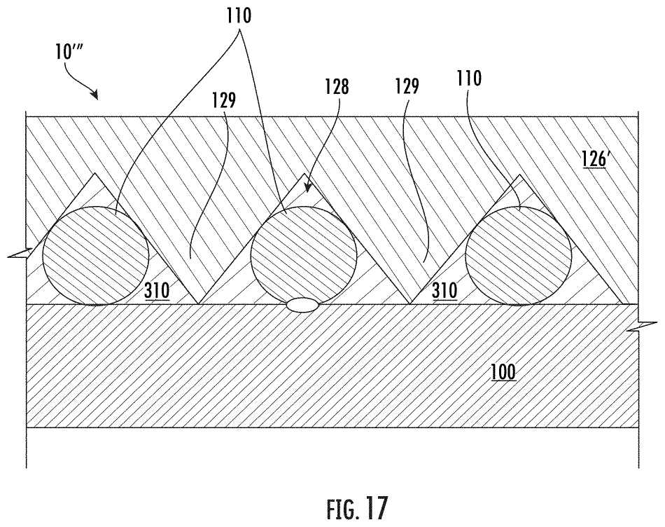

The spacer elements may also be provided in the cover of the optical assembly. FIG. 17 illustrates a non-limiting optical assembly 10′″ wherein the spacer elements are provided by positive features 129 on a surface 127 of the cover 126′ that extend into the spaces between adjacent optical fibers 110. Thus, the positive features 129 occupy the spaces between adjacent optical fibers 110, which therefore minimizes the amount of epoxy between the adjacent optical fibers 110. The cover 126′ may be made from glass, for example, or from a material having a CTE similar to that of the optical fibers (e.g., silicon).

The positive features 129 shown in FIG. 17 are triangular in cross-section, which create V-shaped grooves 128 in which the optical fibers 110 are positioned. Because the V-shaped grooves 128 are not used for optical fiber positioning and alignment, they do not need to be manufactured with precision. It should be understood that embodiments are not limited to V-shaped grooves 128, and that the positive features 129 may take on any shape (e.g., rectangular in cross-section).

Similar to the spacer elements 316 shown in FIG. 15, the positive features 129 defining the spacer elements shown in FIG. 17 reduce the amount of force upon the optical fibers, and may thereby enable the optical assembly to satisfy the thermal shock test.

Embodiments may also increase the ruggedness of the optical assemblies described herein with respect to the thermal shock test by lowering the laser power of the laser beam used to bond the optical fibers 110 to the surface 102 of the substrate 100 (or surface of a metal film disposed on the surface 102 of the substrate 100). Lowering the laser power also lowers the residual stress that is present within the substrate 100 at the bond areas 112. As a non-limiting example, the residual stress within the substrate 100 at the bond areas 112 is less than about 40 MPa, or more preferably less than 30 MPa as measured by a quantitative Exicor® birefringence microscope sold by Hinds™ Instruments of Hillsboro, Oreg. However, the laser power should be enough to reliably bond the optical fibers 110 to the substrate 100. In embodiments, a plasma cleaning process is performed on the surface 102 of the substrate 100 (or surface of the metal film, if employed) to clean the surface such that the surface 102 is substantially free of organic material. Plasma cleaning of the surface reduces the power of the laser beam needed without causing changes to the mechanical strength of the bond areas 112.

Referring to FIG. 12 once again, it is shown that plasma cleaning and lowering of the laser power from 4 W to 2.4 W improves the thermal shock test performance of the optical assembly.

Embodiments may further reduce the stress experienced by the optical fibers by increasing the size of the laser spot size because a smaller laser spot size creates more boundaries within the bond areas 112, were shown to be not beneficial. As a non-limiting example, the spot size of the laser beam may be about 100 μm in diameter. Increasing the spot size of the laser beam also increases the width w of the bond areas 112, as shown in FIG. 1. A laser beam spot size of about 100 μm in diameter may wield bond area widths w within the range of 60 μm to 100 μm, including endpoints. It should be understood that larger laser beam spot sizes and thus larger bond area widths w may be utilized. As a non-limiting example, embodiments may utilize a bond area width w that is greater than 60 μm. Assuming an optical fiber having a diameter of 125 μm, and a bond area width w that is greater than 60 μm, an area of the bond area 112 may be greater than or equal to 0.0075 mm². It should be understood that the optical fibers may take on other diameters and thus the bond area may have different sizes.

It should now be understood that embodiments of the present disclosure provide for techniques to minimize thermally induced stress in optical assemblies so that the optical assemblies may satisfy a thermal shock test as provided herein. It is noted that any of the thermal stress inducing techniques may be used in combination with one or more other techniques. For example, plasma etching and low laser power may be used in conjunction with an epoxy having a natively low CTE (e.g., less than 30 ppm/° C.), or in conjunction with an epoxy layer having spacer elements or filler material.

For the purposes of describing and defining the present invention it is noted that the terms “approximately” and “substantially” are utilized herein to represent the inherent degree of uncertainty that may be attributed to any quantitative comparison, value, measurement, or other representation. The terms “approximately” and “substantially” are also utilized herein to represent the degree by which a quantitative representation may vary from a stated reference without resulting in a change in the basic function of the subject matter at issue.

It is noted that recitations herein of a component of the present invention being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising”.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the disclosure should be construed to include everything within the scope of the appended claims and their equivalents.

1. An assembly comprising:
a substrate comprising a surface;
an array of optical elements bonded to the surface of the substrate;
an epoxy disposed between individual optical elements of the array of optical elements;
a plurality of spacer elements disposed within the epoxy, wherein at least one spacer element of the plurality of spacer elements is positioned between adjacent optical elements of the array of optical elements, and the plurality of spacer elements has a coefficient of thermal expansion that is less than a coefficient of thermal expansion of the epoxy; and
a bond area between each optical element of the array of optical elements and the surface of the substrate, wherein the bond area comprises laser-melted material of the substrate that bonds the optical element to the substrate.

2. The assembly of claim 1, wherein the plurality of spacer elements comprises glass.

3. The assembly of claim 1, wherein the plurality of spacer elements comprises a plurality of non-functional optical fibers.

4. The assembly of claim 1, further comprising a cover disposed on the array of optical elements, wherein the plurality of spacer elements are defined by a plurality of positive features within a surface of the cover that faces the array of optical elements.

5. The assembly of claim 4, wherein the plurality of positive features define a plurality of V-shaped grooves.

6. The assembly of claim 4, wherein the cover comprises glass.

7. The assembly of claim 1, wherein the array of optical elements comprises an array of optical fibers.

8. The assembly of claim 1, wherein the assembly satisfies a thermal shock test comprising one-hundred thermal cycles between −196° C. and 120° C. in thirty seconds.

9. The assembly of claim 1, wherein the coefficient of thermal expansion of the plurality of spacer elements substantially matches a coefficient of thermal expansion of the array of optical elements.

10. An assembly comprising:
a substrate comprising a surface;
an array of optical elements bonded to the surface of the substrate;
an epoxy layer disposed between individual optical elements of the array of optical elements, wherein the epoxy layer comprises:
an epoxy material; and
a plurality of filler particles within the epoxy material, the plurality of filler particles having a coefficient of thermal expansion of less than 20 ppm/° C.; and
a bond area between each optical element of the array of optical elements and the surface of the substrate, wherein the bond area comprises laser-melted material of the substrate that bonds the optical element to the substrate.

11. The assembly of claim 10, wherein the coefficient of thermal expansion of the plurality of filler particles is negative and a coefficient of thermal expansion of the epoxy material is within a range of 100 ppm/° C. and 200 ppm/° C., including endpoints.

12. The assembly of claim 11, wherein the plurality of filler particles comprises zirconia tungstate.

13. The assembly of claim 11, wherein the plurality of filler particles each have a diameter that is less than or equal to 80 μm.

14. The assembly of claim 10, wherein the epoxy layer comprises less than or equal to 30% weight concentration (w/w) of the plurality of filler particles.

15. The assembly of claim 10, wherein the assembly satisfies a thermal shock test comprising one-hundred thermal cycles between −196° C. and 120° C. in thirty seconds.

16. An assembly comprising:
a substrate comprising a plasma-cleaned surface that is substantially devoid of organic material;
an array of optical elements bonded to the plasma-cleaned surface of the substrate;
an epoxy disposed between individual optical elements of the array of optical elements; and
a bond area between each optical element of the array of optical elements and the plasma-cleaned surface of the substrate, wherein the bond area comprises laser-melted material of the substrate that bonds the optical element to the substrate, and the bond area has an area that is greater than or equal to 0.0075 mm².

17. The assembly of claim 16, wherein a residual stress within the substrate at the bond area between each optical element of the array of optical elements is less than or equal to 40 MPa.

18. The assembly of claim 16, wherein the assembly satisfies a thermal shock test comprising one-hundred thermal cycles between −196° C. and 120° C. in thirty seconds.

19. The assembly of claim 16, wherein the epoxy has one or more of the following:
a coefficient of thermal expansion of less than or equal to 30 ppm/° C.; and
a coefficient of thermal expansion and a Young's modulus such that a product between the coefficient of thermal expansion and the Young's modulus is less than or equal to 70,000 ppm*MPa/° C.

20. The assembly of claim 19, wherein the epoxy comprises A535 AN.
